(19) United States
(12) Patent Application Publication
(10) Pub. No.: US 2005/0225254 A1
(43) Pub. Date: Oct. 13, 2005

(54) Display device

(75) Inventors: Kazumasa Takai, Kakamigahara-shi (JP); Hitoshi Yasuda, Mizuho-shi (JP)

Correspondence Address: Barry E. Bretschneider;Morrison & Foerster LLP, Suite 300, 1650 Tysons Boulevard, McLean, VA, 22102, US

(73) Assignee: Sanyo Electric Co., Ltd., Moriguchi-city (JP)

(21) Appl. No.: 11/102,871

(22) Filed: Apr. 11, 2005

(30) Foreign Application Priority Data
Apr. 13, 2004 (JP) 2004-118124
Apr. 7, 2005 (JP) 2005-110818

(51) Int. Cl. G09G 3/30

(52) U.S. Cl. 315/169.3; 345/76; 345/62

(57) ABSTRACT

In an organic EL display device, a power loss of a driver transistor is suppressed and heating and power consumption of the display device is reduced. A plurality of R pixels is provided with a first power supply circuit, a plurality of G pixels is provided with a second power supply circuit and a plurality of B pixels is provided with a third power supply circuit. The first power supply circuit generates a voltage PVDD-R and a voltage CV-R. The second power supply circuit generates a voltage PVDD-G and a voltage CV-G. Also the third power supply circuit generates a voltage PVDD-B and a voltage CV-B. Each of the voltages generated by the power supply circuits is independently controlled by a micro processing unit in order for the white balance adjustment.

### CROSS-REFERENCE OF THE INVENTION

This invention is based on Japanese Patent Applications No. 2004-118124 and No. 2005-110818, the content of which is incorporated herein by reference in its entirety.

### BACKGROUND OF THE INVENTION

1. Field of the Invention

This invention relates to a display device, specifically to a display device including pixels corresponding to a plurality of colors such as three primary colors R, G and B.

2. Description of the Related Art

An organic EL device using an organic electroluminescence element (hereafter referred to as organic EL element) has been receiving attention in recent years as a display device which would replace a CRT and an LCD. An active matrix type organic EL display device having a thin film transistor (hereafter referred to as a TFT) that serves as a driver transistor supplying a drive current to an organic EL element in each of pixels has been developed.

In order to realize a full-color display, the organic EL display device has a red (R) pixel including an organic EL element emitting red light, a green (G) pixel including an organic EL element emitting green light and a blue (B) pixel including an organic EL element emitting blue light. There is another organic EL display device that realizes the full color display using a white light from an organic EL element emitting white light that goes through red, green and blue color filters corresponding to the R, G and B pixels.

Each of the organic EL elements emit the light driven by a current supplied through a driver transistor corresponding to data representing red, green or blue image. The desired full color display is realized by mixing the red, green and blue light emitted from the organic EL elements.

A maximum value of a drive current I to drive an organic EL element 100 to emit light is determined by a voltage applied between a source and a drain of a driver transistor 101, i.e. a difference between a voltage PVDD and a voltage CV, as shown in FIG. 14. And maximum brightness of the organic EL element 100 is determined by the maximum value of the drive current I. Further details may be found in Japanese Patent Application Publication No. 2003-241711.

Light emission efficiency of the organic EL element for each of the three primary colors, that is, a ratio of the brightness to the drive current is not equal to each other. Therefore, in order to perform white balance adjustment at the maximum brightness of each of the organic EL elements, the voltages PVDD and CV are set to common voltages adjusted to a pixel including an organic EL element of a color that is lowest in the light emission efficiency. As a result, unnecessarily high power supply voltage (the difference between the voltage PVDD and the voltage CV, defined as PVDD-CV) is supplied to pixels including organic EL elements of other colors which are higher in the light emission efficiency, causing problems of power loss in the driver transistors and increased heating and power consumption in the display device.

When the white balance adjustment is performed on a display device using time division multiplex drive such as the one disclosed in Japanese Patent Application Publication No. 2003-241711 in order to implement a multiple gray level display, the R, G and B pixels require emission time different from each other in order to obtain necessary brightness, exacerbating accuracy in reproducing the gray level.

### SUMMARY OF THE INVENTION

The invention provides a display device that includes a plurality of first pixels, each of which includes a first light emitting element that emits light of a first color and a first driver transistor that drives the first light emitting element, a plurality of second pixels, each of which includes a second light emitting element that emits light of a second color and a second driver transistor that drives the second light emitting element, a plurality of third pixels, each of which includes a third light emitting element that emits light of a third color and a third driver transistor that drives the third light emitting element, a data driver providing the first, second and third pixels with signal voltages corresponding to display data, a first power supply circuit supplying a first potential to the first driver transistors so that currents corresponding to the signal voltages for respective first pixels flow through corresponding first light emitting elements, a second power supply circuit supplying a second potential to the second driver transistors so that currents corresponding to the signal voltages for respective second pixels flow through corresponding second light emitting elements, a third power supply circuit supplying a third potential to the third driver transistors so that currents corresponding to the signal voltages for respective third pixels flow through corresponding third light emitting elements.

The invention also provides a display device that includes a first pixel having a first light emitting element that emits light of a first color and a first driver transistor that drives the first light emitting element, a second pixel having a second light emitting element that emits light of a second color and a second driver transistor that drives the second light emitting element, a data driver providing the first and second pixels with signal voltages corresponding to display data, a first power supply circuit supplying a first potential to the first driver transistor so that a current corresponding to the signal voltage of the first pixel flows through the first light emitting element, and a second power supply circuit supplying a second potential to the second driver transistor so that a current corresponding to the signal voltage of the second pixel flows through the second light emitting element.

### BRIEF DESCRIPTION OF THE DRAWINGS

FIG. 1 shows an entire structure of an example of an organic EL display device according to a first embodiment of this invention.

FIG. 2 is a circuit diagram of a pixel in the organic EL display device according to the first embodiment of this invention.

FIG. 3 is a timing chart showing driving timing of the organic EL display device according to the first embodiment of this invention.

FIG. 4 is a timing chart showing driving timing of the organic EL display device according to the first embodiment of this invention.

FIG. 5 shows an entire structure of another example of the organic EL display device according to the first embodiment of this invention.

FIG. 6 shows current-voltage characteristics of a driver transistor.

FIG. 7 is a circuit diagram showing an example of a display panel portion of the organic EL display device according to the first embodiment of this invention.

FIG. 8 is a circuit diagram showing another example of the display panel portion of the organic EL display device according to the first embodiment of this invention.

FIG. 9 is a circuit diagram showing R, G and B pixels in an organic EL display device according to a second embodiment of this invention.

FIG. 10 is a circuit diagram showing an example of a display panel portion of the organic EL display device according to the second embodiment of this invention.

FIG. 11 is a circuit diagram showing another example of the display panel portion of the organic EL display device according to the second embodiment of this invention.

FIG. 12 shows operation of the organic EL display device according to the first embodiment of this invention.

FIG. 13 shows operation of the organic EL display device according to the second embodiment of this invention.

FIG. 14 shows a pixel in an organic EL display device according to a conventional art.

FIG. 15 shows a cross-sectional view of a pixel with a color filter as a modification to the embodiments of this invention.

### DETAILED DESCRIPTION OF THE INVENTION

Next, an organic EL display device according to a first embodiment of this invention will be described hereafter referring to figures. First, a structure of a display device using time division multiplex drive to which this invention is applied will be described.

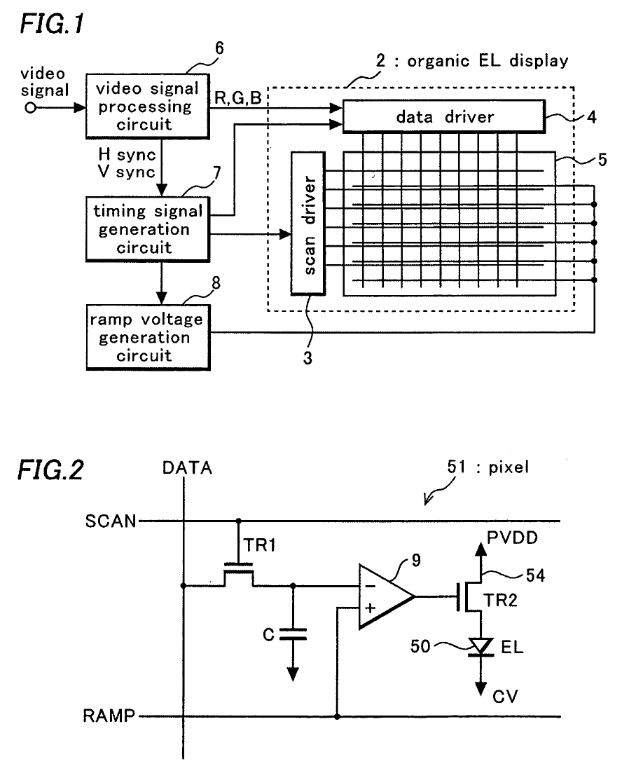

This organic EL display device includes connecting a scan driver 3 and a data driver 4 to a display panel 5 having a plurality of pixels arrayed in a matrix form, as shown in FIG. 1. Video signals from an image source such as a TV receiver are fed to an image signal processing circuit 6 where signal processing required for displaying the image is performed. Resulting three primary color image signals R, G and B are fed to the data driver 4 in an organic EL display 2.

A horizontal synchronization signal Hsync and a vertical synchronization signal Vsync obtained in the image signal processing circuit 6 are fed to a timing signal generation circuit 7. A timing signal generated in the timing signal generation circuit 7 is fed to the scan driver 3 and the data driver 4. The timing signal is also fed to a ramp voltage generation circuit 8 in which a ramp voltage is generated. The ramp voltage is fed to each pixel in the display panel 5, and is used to drive the organic display 2, as will be described hereinafter. The circuits, drivers and the organic EL display shown in FIG. 1 are connected to a power supply circuit (not shown).

The display panel 5 includes a plurality of pixels arrayed in a matrix form. A circuit structure of each pixel 51 is shown in FIG. 2. Each pixel 51 includes an organic EL element 50 made of an organic layer, a driver transistor TR2 that controls a current flow to the organic EL element 50 corresponding to an on/off control signal inputted to its gate, a write transistor TR1 that is turned on when a scanning voltage from the scan driver 3 is applied to its gate, a capacitor C for data retention to which a data voltage from the data driver 4 is applied when the write transistor TR1 is turned on and a comparator 9 that compares the ramp voltage supplied from the ramp voltage generation circuit 8 and inputted to a non-inverted input terminal (+) of the comparator 9 with an output voltage from the capacitor C inputted to an inverted input terminal (−) of the comparator 9. An output of the comparator 9 is fed to the gate of the driver transistor TR2.

A source of the driver transistor TR2 is connected to a current supply line 54 to which a voltage PVDD is applied. A drain of the driver transistor TR2 is connected to an anode of the organic EL element 50. A voltage CV is applied to a cathode of the organic EL element 50.

An electrode (source, for example) of the write transistor TR1 is connected to the data driver 4, while another electrode (drain, for example) of the write transistor TR1 is connected to one end of the capacitor C and the inverted input terminal of the comparator 9. The non-inverted input terminal of the comparator 9 is connected to an output of the ramp voltage generation circuit 8.

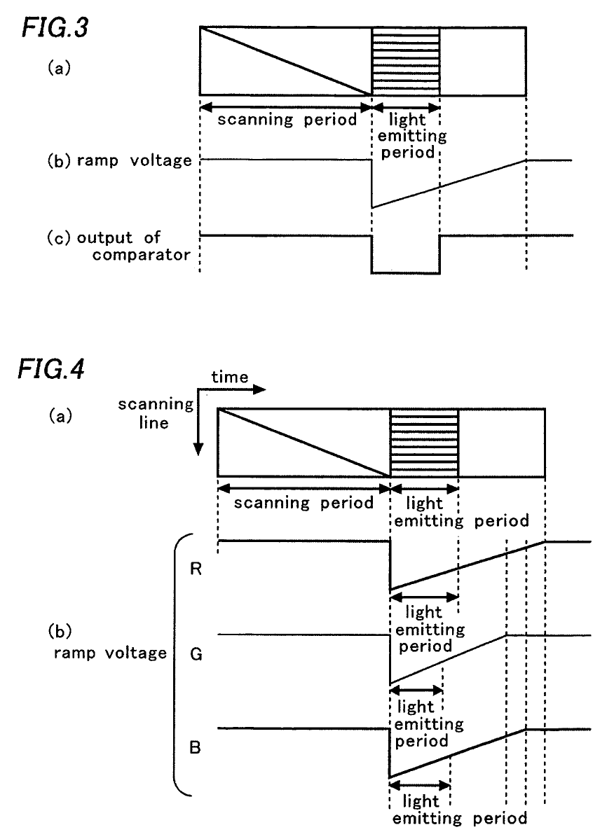

In the organic EL display 2, one field period is divided into a former scanning period and a latter light emitting period, as seen from (a) in FIG. 3. The light emitting period varies by pixel. The scanning voltage from the scan driver 3 is applied through a horizontal line to the write transistor TR1 constituting each pixel 51 to turn on the write transistor TR1. Thus the data voltage from the data driver 4 is applied to the capacitor C and charges corresponding to the data voltage are stored in the capacitor C. As a result, one field of data is set in all of the pixels constituting the organic EL display 2.

The ramp voltage generation circuit 8 keeps a high voltage during the former scanning period and generates the ramp voltage that varies linearly from a low voltage to the high voltage during the latter light emitting period in every field period, as seen from (b) in FIG. 3. During the former scanning period, the output of the comparator 9 remains high regardless the input voltage to the inverted input terminal because the high voltage from the ramp voltage generation circuit 8 is applied to the non-inverted input terminal of the comparator 9, as seen from (c) in FIG. 3.

During the latter light emitting period, immediately after the ramp voltage from the ramp voltage generation circuit 8 is applied to the non-inverting input terminal of the comparator 9, the output of the comparator takes a high value or a low value, depending on a result of comparison between the ramp voltage and an output voltage of the capacitor C (data voltage), as seen from (c) in FIG. 3. That is, the output of the comparator 9 is low in a period during which the ramp voltage is lower than the data voltage, and the output of the comparator 9 is high in a period during which the ramp voltage is higher than the data voltage. Note that duration of the period during which the output of the comparator 9 remains low extends proportionally to the data voltage.

As described above, the driver transistor TR2 is turned on to drive the organic EL element 50 for the period proportional to the data voltage, by making the output of the comparator 9 low only for the period. As a result, the organic EL element 50 in each pixel 51 emits light for a period proportional to the data voltage for each pixel 51 in one field period, thus the multiple gray level display is realized.

The organic EL display device described above does not require fast scanning and does not cause a false contour, since it takes only a single scan in one field period to perform the multiple gray level display. Also, since the organic EL display device adopts digital drive method, it is not easily affected by variation in characteristics of the driver transistor TR2. In addition, power consumption can be reduced by lowering the power supply voltage.

Furthermore, by making a rate of change (gradient) in the ramp voltage for each of the three primary colors on a line different from those for the other colors as seen from (a) and (b) in FIG. 4, a ratio of the light emitting period to the data voltage can be modified to perform the white balance adjustment. In this case, an R ramp voltage generation circuit 81, a G ramp voltage generation circuit 82 and a B ramp voltage generation circuit 83 are provided each for the line of respective one of the three primary colors R, G and B, as shown in FIG. 5.

Light emission efficiency of each of the three primary colors R, G and B, that is, a ratio of the brightness to the drive current is not equal to each other. Therefore, in order to perform white balance adjustment at the maximum brightness of each of the organic EL elements 50, the voltages PVDD and CV have been set to common voltages adjusted to pixels including an organic EL element 50 of a color that is lowest in the light emission efficiency. As a result, unnecessarily high power supply voltage (PVDD-CV) is supplied to pixels 51 including organic EL elements 50 of other colors which are higher in the light emission efficiency, causing problems of power loss in the driver transistors TR2 and increased heating and power consumption in the display device.

Also, when the white balance adjustment is performed by making the rate of change (gradient) in the ramp voltage for each of the three primary colors different from those for the other colors to modify the ratio of the light emitting period to the data voltage, the light emitting periods for the three primary colors after the white balance adjustment become different from each other. This causes a problem that the accuracy in the multiple gray level reproduction is exacerbated.

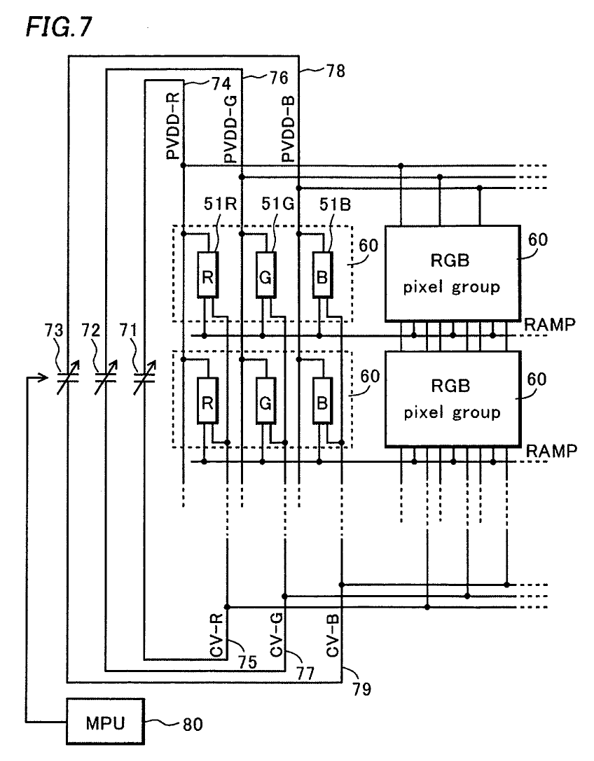

To solve the problem, each of the driver transistors TR2 driving the organic EL elements of the three primary colors R, G and B is provided with an individual power supply circuit that applies a power supply voltage to the corresponding driver transistor TR2. A structure of an example of such an organic EL display device is explained referring to FIG. 7. FIG. 7 shows a display panel 5 and its peripheral circuit of the organic EL display device shown in FIG. 1. Structures of the scan driver 3, the data driver 4 and others are the same as those in the organic EL display device explained referring to FIG. 1. A plurality of R pixels 51R, a plurality of G pixels 51G and a plurality of B pixels 51B are arrayed in a matrix form, as shown in FIG. 7. FIG. 7 shows that one each of the three pixels 51R, 51G and 51B arrayed in a row direction form a pixel group 60 and that a plurality of the pixel groups 60 is arrayed in the matrix form.

The R pixel 51R, the G pixel 51G and the B pixel 51B have the same structure as the pixel 51 shown in FIG. 2. Difference among the pixels 51R, 51G and 51B is only in the organic layer of the organic EL element 50 that emits light of each of the primary colors R, G and B. A common ramp voltage is supplied to the plurality of R pixels 51R, the plurality of G pixels 51G and the plurality of B pixels 51B.

And a first power supply circuit 71 is provided corresponding to the plurality of R pixels 51R, a second power supply circuit 72 is provided corresponding to the plurality of G pixels 51G, and a third power supply circuit 73 is provided corresponding to the plurality of B pixels 51B. The first power supply circuit 71 includes a DC-DC converter that converts an input DC voltage into a desired high DC voltage and generates a voltage PVDD-R and a voltage CV-R.

And the second power supply circuit 72 is composed of a similar DC-DC converter and generates a voltage PVDD-G and a voltage CV-G. Also the third power supply circuit 73 includes a similar DC-DC converter and generates a voltage PVDD-B and a voltage CV-B. Each of the voltages generated by the power supply circuits 71, 72 and 73 is independently controlled by a micro processing unit 80 in order for the white balance adjustment.

The voltage PVDD-R from the first power supply circuit 71 is fed in common to sources of driver transistors TR2 in the plurality of R pixels 51R through a power supply line 74, while the voltage CV-R from the first power supply circuit 71 is fed in common to cathodes of organic EL elements 50 in the plurality of R pixels 51R through a power supply line 75.

Also, the voltage PVDD-G from the second power supply circuit 72 is fed in common to sources of driver transistors TR2 in the plurality of G pixels 51G through a power supply line 76, while the voltage CV-G from the second power supply circuit 72 is fed in common to cathodes of organic EL elements 50 in the plurality of G pixels 51G through a power supply line 77.

Similarly, the voltage PVDD-B from the third power supply circuit 73 is fed in common to sources of driver transistors TR2 in the plurality of B pixels 51B through a power supply line 78, while the voltage CV-B from the third power supply circuit 73 is fed in common to cathodes of organic EL elements 50 in the plurality of B pixels 51B through a power supply line 79.

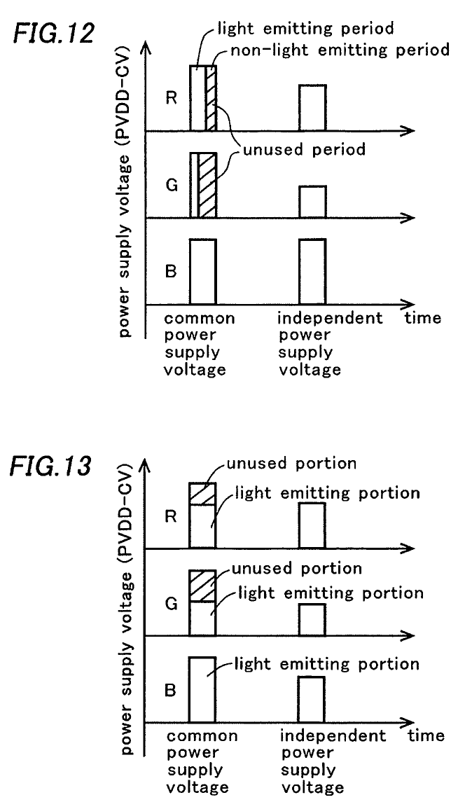

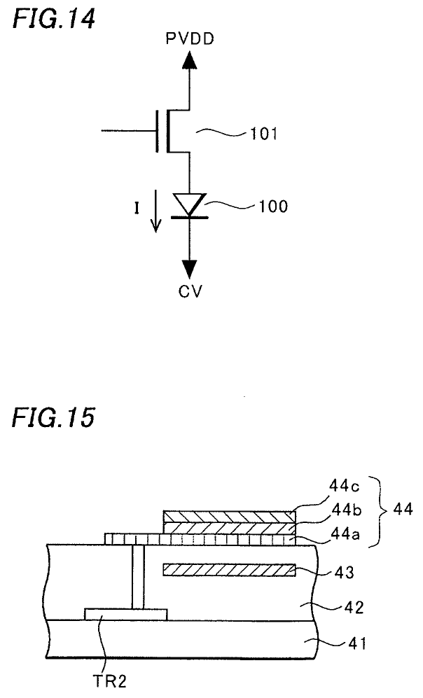

FIG. 12 shows a driving method of the organic EL display device according to the embodiment. As shown in the figure, when each pixel R, G or B, that corresponds to each of the three primary colors R, G and B respectively, is provided with the common power supply voltage (PVDD-CV), the power supply voltage is set to a high voltage in order to adjust it to the B pixel that is lowest in the light emission efficiency among the three. The light emitting periods for the R pixel that has higher light emission efficiency and the G pixel that has even higher light emission efficiency are set short in order to adjust the white balance under this condition in the organic EL display devices shown in FIG. 1 and FIG. 5 that use the time division multiplex drive, causing problems of power loss in the driver transistors TR2, increased heating and power consumption in the display device and exacerbation of accuracy in the multiple gray level reproduction.

On the other hand, with the driving method of the organic EL display device according to the embodiment that uses the time division multiplex drive, the pixels of each of the three primary colors R, G and B are provided with the best suited power supply voltage, because the pixels of each of the three primary colors R, G and B is provided with the independent power supply voltage. The power supply voltages are controlled by the micro processing unit 80 so that the power supply voltage supplied to each of the pixels R, G and B is decreased in the order from the low light emission efficiency to the high light emission efficiency, that is, in the order of B pixels, R pixels, G pixels. Note that the light emission efficiency is not always decreased in the order of B pixels, R pixels, G pixels, since the light emission efficiency depends on characteristics of the organic layer that constitutes the organic EL element 50.

Since the white balance can be adjusted by independently optimizing each of the power supply voltages supplied to each of the pixels R, G and B respectively, while the light emitting periods for the pixels R, G and B are set equal to each other, the accuracy in the multiple gray level reproduction is improved.

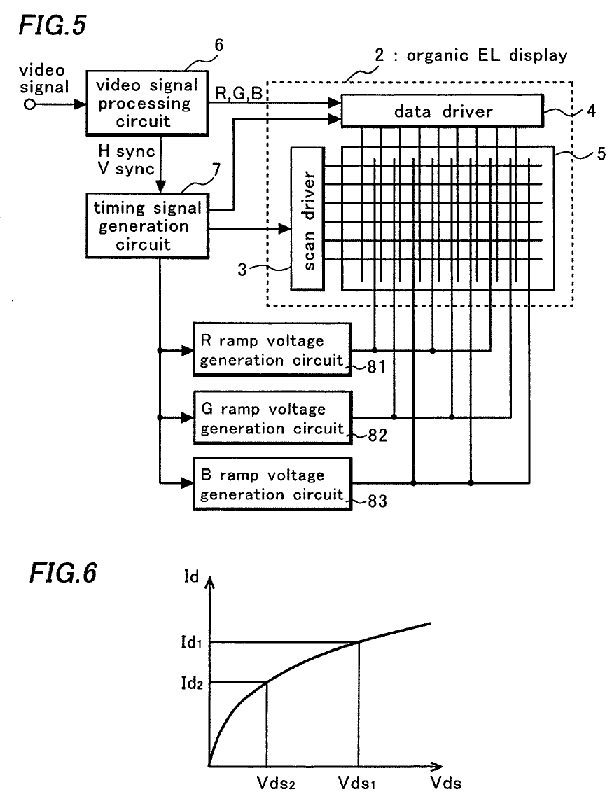

Now, a reason why providing each of the pixels R, G and B with the independent power supply voltage (PVDD-CV) suppresses the power loss in the driver transistor TR2 is explained hereafter, referring to FIG. 6. FIG. 6 shows current Id versus voltage Vds characteristics of the driver transistor TR2 that is made of a thin film transistor. Id means a drain current and Vds means a voltage between the source and the drain of the driver transistor TR2.

As the current Id is reduced from Id1 to Id2 by optimizing the independent power supply voltage, so does the voltage Vds from Vds1 to Vds2. Since the current Ids versus voltage Vds characteristics show non-linear (saturated) characteristics, a rate of decrease of the voltage Vds is much larger than that of the current Ids. That is, as the power supply voltage is reduced by optimizing the independent power supply voltage and thus the voltage Vds is reduced significantly as a result, the power loss in the driver transistor TR2 is suppressed. The voltage CV-R generated by the first power supply circuit 71, the voltage CV-G generated by the second power supply circuit 72 and the voltage CV-B generated by the third power supply circuit 73 may be either different voltages from each other or the same voltage. When the voltages CV-R, CV-G and CV-B are different from each other, the cathode of the organic EL element 50 in the R pixel 51R, the cathode of the organic EL element 50 in the G pixel 51G and the cathode of the organic EL element 50 in the B pixel 51B are physically separated from each other. When the voltages CV-R, CV-G and CV-B are all the same, on the other hand, the cathodes are not necessarily separated and may be physically unified.

In the organic EL display device shown in FIG. 7, the first power supply circuit 71, the second power supply circuit 72 and the third power supply circuit 73 are provided, each corresponding to each of the pixels R, G and B, respectively. Instead, the pixels R, G and B may be divided into two groups and each of the groups may be provided with a common power supply voltage.

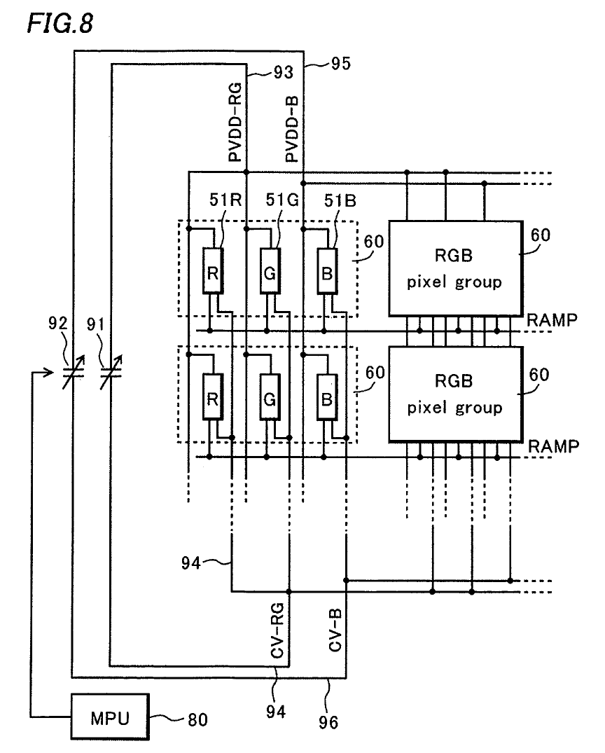

A structure of an example of such an organic EL display device is explained referring to FIG. 8. FIG. 8, as with FIG. 7, shows a display panel 5 and its peripheral circuit of the organic EL display device. In the organic display device, the R pixels 51R and the G pixels 51G are grouped into the same group because the light emission efficiency of the organic EL element in the R pixel 51R is similar to that in the G pixel 51G, while the B pixels 51B belong to another group. This grouping is just an example. Different grouping may be made according to the light emission efficiency of actual organic EL elements. A detailed circuit structure of the display panel 5 and its peripheral circuit will be explained hereafter.

In FIG. 8, as in FIG. 7, a plurality of R pixels 51R, a plurality of G pixels 51G and a plurality of B pixels 51B are arrayed in a matrix form. FIG. 8 shows that one each of the three pixels 51R, 51G and 51B arrayed in a row direction form a pixel group 60 and that a plurality of the pixel groups 60 is arrayed in the matrix form.

The R pixel 51R, the G pixel 51G and the B pixel 51B have the same structure as the pixel 51 shown in FIG. 2. Difference among the pixels 51R, 51G and 51B is only in the organic layer of the organic EL element 50 that emits light of each of the primary colors R, G and B. A common ramp voltage is supplied to the plurality of R pixels 51R, the plurality of G pixels 51G and the plurality of B pixels 51B.

A first power supply circuit 91 is provided corresponding to the plurality of R pixels 51R and the plurality of G pixels 51G while a second power supply circuit 92 is provided corresponding to the plurality of B pixels 51B. The first power supply circuit 91 includes a DC-DC converter that converts an input DC voltage into a desired high DC voltage and generates a voltage PVDD-RG and a voltage CV-RG. Also the second power supply circuit 92 includes a similar DC-DC converter and generates a voltage PVDD-B and a voltage CV-B. Each of the voltages generated by the power supply circuits 91 and 92 is independently controlled by a micro processing unit 80 in order for the white balance adjustment.

The voltage PVDD-RG from the first power supply circuit 91 is fed in common to sources of driver transistors TR2 in the plurality of R pixels 51R and to sources of driver transistors TR2 in the plurality of G pixels 51G through a power supply line 93, while the voltage CV-RG from the first power supply circuit 91 is fed in common to cathodes of the organic EL elements 50 in the plurality of R pixels 51R and to cathodes of the organic EL elements 50 in the plurality of G pixels 51G through a power supply line 94.

Also, the voltage PVDD-B from the second power supply circuit 92 is fed in common to sources of driver transistors TR2 in the plurality of B pixels 51B through a power supply line 95, while the voltage CV-B from the second power supply circuit 92 is fed in common to cathodes of organic EL elements 50 in the plurality of B pixels 51B through a power supply line 96. As described above, the pixels with the organic EL elements 50 having the light emission efficiency close to each other are in the same group. The power supply circuit providing this group with the voltages is made independent from the power supply circuit providing the other group with the other voltages. Practically the same effect can be obtained with this display device as the display device shown in FIG. 7. The voltage CV-RG generated by the first power supply circuit 91 and the voltage CV-B generated by the second power supply circuit 92 may be either different voltages from each other or the same voltage. When the voltages CV-RG and CV-B are different from each other, the cathode of the organic EL element 50 in the R pixel 51R and the cathode of the organic EL element 50 in the G pixel 51G are physically separated from the cathode of the organic EL element 50 in the B pixel 51B. When the voltages CV-RG and CV-B are the same, on the other hand, the cathodes are not necessarily separated and may be physically unified.

Next, an organic EL display device according to a second embodiment of this invention will be described hereafter referring to figures. In the organic EL display device according to the first embodiment, the power supply circuits providing the driver transistors TR2 in the pixels R, G and B with the power supply voltages are made independent from each other in the organic EL display device using the time division multiplex drive. In the organic EL display device according to the second embodiment, on the other hand, the power supply circuits providing the driver transistors TR2 in the pixels R, G and B with the power supply voltages are made independent from each other in the organic EL display device using analog voltage drive, not the time division multiplex drive.

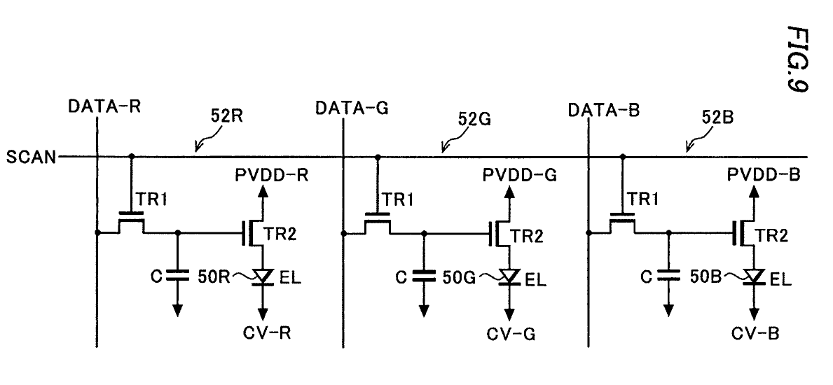

FIG. 9 is a circuit diagram showing each of pixels R, G and B in this organic EL display device. The entire structure of this organic EL display device is the same as the structure of the display device shown in FIG. 1, except that the ramp voltage generation circuit 8 is removed. A display panel 5 includes R pixels 52R, G pixels 52G and B pixels 52B arrayed in a matrix form.

Each of the pixels 52R, 52G and 52B includes each of organic EL elements 50R, 50G and 50B made of an organic layer and emits light of each of the three primary colors R, G and B, respectively, a driver transistor TR2 that controls a current flow to each of the organic EL elements 50R, 50G and 50B corresponding to each of analog data voltages DATA-R, DATA-G and DATA B, a write transistor TR1 that is turned on when a scanning voltage from the scan driver 3 is applied to its gate, a capacitor C for data retention to which each of the analog data voltages DATA-R, DAT-G and DATA-B from the data driver 4 is applied when the write transistor TR1 is turned on. The analog data voltage is provided to the gate of the driver transistor TR2.

A voltage PVDD-R is applied to a source of the driver transistor TR2 in the R pixel 52R. A drain of the driver transistor TR2 is connected to an anode of the organic EL element 50R. A voltage CV-R is applied to a cathode of the organic EL element 50R. A voltage PVDD-G is applied to a source of the driver transistor TR2 in the G pixel 52G. A drain of the driver transistor TR2 is connected to an anode of the organic EL element 50G. A voltage CV-G is applied to a cathode of the organic EL element 50G A voltage PVDD-B is applied to a source of the driver transistor TR2 in the B pixel 52B. A drain of the driver transistor TR2 is connected to an anode of the organic EL element 50B. A voltage CV-B is applied to a cathode of the organic EL element 50B.

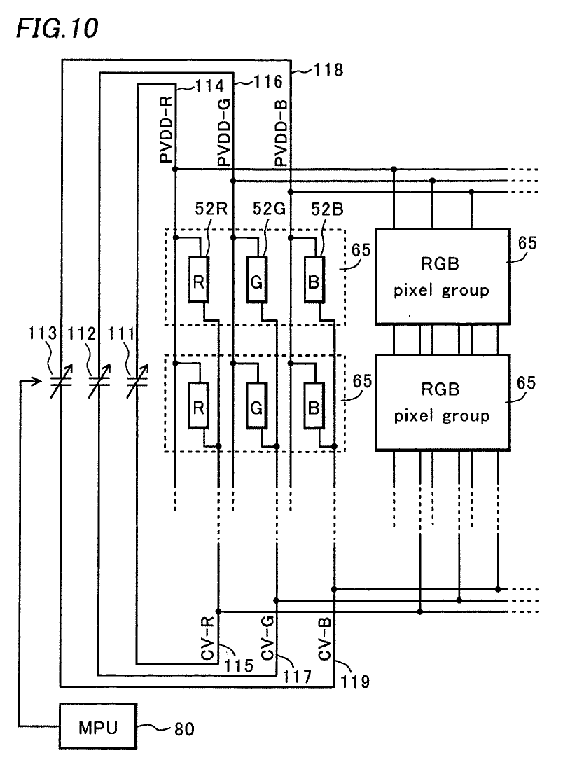

A structure of an example of such an organic EL display device is explained more in detail, referring to FIG. 10. FIG. 10 shows a display panel 5 and its peripheral circuit of the organic EL display device shown in FIG. 1. Structures of the scan driver 3, the data driver 4 and others are the same as those in the organic EL display device explained referring to FIG. 1. A plurality of R pixels 52R, a plurality of G pixels 52G and a plurality of B pixels 52B are arrayed in a matrix form, as shown in FIG. 10. FIG. 10 shows that one each of the three pixels 52R, 52G and 52B arrayed in a row direction form a pixel group 65 and that a plurality of the pixel groups 65 is arrayed in the matrix form.

And a first power supply circuit 111 is provided corresponding to the plurality of R pixels 52R, a second power supply circuit 112 is provided corresponding to the plurality of G pixels 52G, and a third power supply circuit 113 is provided corresponding to the plurality of B pixels 52B. The first power supply circuit 111 includes a DC-DC converter that converts an input DC voltage into a desired high DC voltage and generates a voltage PVDD-R and a voltage CV-R.

And the second power supply circuit 112 includes a similar DC-DC converter and generates a voltage PVDD-G and a voltage CV-G. Also the third power supply circuit 113 includes a similar DC-DC converter and generates a voltage PVDD-B and a voltage CV-B. Each of the voltages generated by the power supply circuits 111, 112 and 113 is independently controlled by a micro processing unit 80 in order for the white balance adjustment.

The voltage PVDD-R from the first power supply circuit 111 is fed in common to sources of driver transistors TR2 in the plurality of R pixels 52R through a power supply line 114, while the voltage CV-R from the first power supply circuit 111 is fed in common to cathodes of organic EL elements 50R in the plurality of R pixels 52R through a power supply line 115.

Also, the voltage PVDD-G from the second power supply circuit 112 is fed in common to sources of driver transistors TR2 in the plurality of G pixels 52G through a power supply line 116, while the voltage CV-G from the second power supply circuit 112 is fed in common to cathodes of organic EL elements 50G in the plurality of G pixels 52G through a power supply line 117.

Similarly, the voltage PVDD-B from the third power supply circuit 113 is fed in common to sources of driver transistors TR2 in the plurality of B pixels 52B through a power supply line 118, while the voltage CV-B from the third power supply circuit 113 is fed in common to cathodes of organic EL elements 50B in the plurality of B pixels 52B through a power supply line 119.

FIG. 13 shows a driving method of the organic EL display device according to the embodiment. As shown in the figure, when R, G and B pixels that correspond to the three primary colors R, G and B are provided with the common power supply voltage (PVDD-CV), the power supply voltage is set to a high voltage in order to adjust it to the B pixel 52B that is lowest in the light emission efficiency among the three. When the white balance is adjusted under this condition, a problem of excessive power consumption arises in the R pixel 52R that has relatively high light emission efficiency and in the G pixel 52G that has even higher light emission efficiency.

With the driving method of the organic EL display device according to the embodiment, on the other hand, the best suited power supply voltage can be applied to each of the R, G and B pixels, because each of the R, G and B pixels is provided with the independent power supply voltage. As a result, the power loss in the driver transistor TR2 is minimized and the heating of the display device is prevented. The power supply voltages are controlled by the micro processing unit 80 so that the power supply voltage supplied to each of the pixels R, G and B is decreased in the order from the low light emission efficiency to the high light emission efficiency, that is, in the order of B pixels, R pixels, G pixels. Note that the light emission efficiency is not always decreased in the order of B pixels, R pixels, G pixels, since the light emission efficiency depends on characteristics of the organic layer that constitutes the organic EL element. The voltage CV-R generated by the first power supply circuit 111, the voltage CV-G generated by the second power supply circuit 112 and the voltage CV-B generated by the third power supply circuit 113 may be either different voltages from each other or the same voltage. When the voltages CV-R, CV-G and CV-B are different from each other, the cathode of the organic EL element 50R in the R pixel 51R, the cathode of the organic EL element 50G in the G pixel 51G and the cathode of the organic EL element 50B in the B pixel 51B are physically separated from each other. When the voltages CV-R, CV-G and CV-B are all the same, on the other hand, the cathodes are not necessarily separated and may be physically unified.

In the organic EL display device shown in FIG. 10, the first power supply circuit 111, the second power supply circuit 112 and the third power supply circuit 113 are provided, each corresponding to each of the pixels R, G and B, respectively. Instead, the pixels R, G and B may be divided into two groups and each of the groups may be provided with a common power supply voltage.

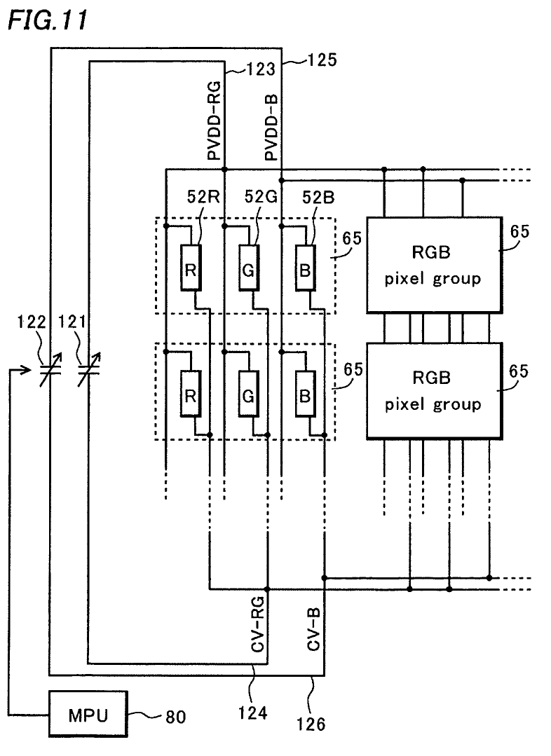

A structure of an example of such an organic EL display device is explained referring to FIG. 11. FIG. 11, shows a display panel 5 and its peripheral circuit of the organic EL display device. In the organic display device, the R pixels 52R and the G pixels 52G are grouped into the same group while the remaining B pixels 52B are classified into a separate group, because the light emission efficiency of the organic EL element 50R in the R pixel 52R is closer to that of the organic EL element 50G in the G pixel 52G than that of the organic EL element 50B in the B pixel 52B. The grouping described above is just an example. Different classifications may be made according to the light emission efficiency of actual organic EL elements. A detailed circuit structure of the display panel 5 and its peripheral circuit will be explained hereafter.

In FIG. 11, a plurality of R pixels 52R, a plurality of G pixels 52G and a plurality of B pixels 52B are arrayed in a matrix form. FIG. 11 shows that one each of the three pixels 52R, 52G and 52B arrayed in a row direction form a pixel group 65 and that a plurality of the pixel groups 65 is arrayed in the matrix form.

A first power supply circuit 121 is provided corresponding to the plurality of R pixels 52R and the plurality of G pixels 52G while a second power supply circuit 122 is provided corresponding to the plurality of B pixels 52B. The first power supply circuit 121 includes a DC-DC converter that converts an input DC voltage into a desired high DC voltage and generates a voltage PVDD-RG and a voltage CV-RG

Also the second power supply circuit 122 includes a similar DC-DC converter and generates a voltage PVDD-B and a voltage CV-B. Each of the voltages generated by the power supply circuits 121 and 122 is independently controlled by a micro processing unit 80 in order for the white balance adjustment.

The voltage PVDD-RG from the first power supply circuit 121 is fed in common to sources of driver transistors TR2 in the plurality of R pixels 52R and to sources of driver transistors TR2 in the plurality of G pixels 52G through a power supply line 123, while the voltage CV-RG from the first power supply circuit 121 is fed in common to cathodes of the organic EL elements 50R in the plurality of R pixels 52R and to cathodes of the organic EL elements 50G in the plurality of G pixels 52G through a power supply line 124.

Also, the voltage PVDD-B from the second power supply circuit 122 is fed in common to sources of driver transistors TR2 in the plurality of B pixels 52B through a power supply line 125, while the voltage CV-B from the second power supply circuit 122 is fed in common to cathodes of organic EL elements 50B in the plurality of B pixels 52B through a power supply line 126.

As described above, the pixels with the organic EL elements having similar light emission efficiencies belong to the same group. The power supply circuit providing this group with the voltages is made independent from the power supply circuit providing the other group with the other voltages. Practically the same effect can be obtained with this display device as the display device shown in FIG. 10. The voltage CV-RG generated by the first power supply circuit 121 and the voltage CV-B generated by the second power supply circuit 122 may be either different voltages from each other or the same voltage. When the voltages CV-RG and CV-B are different from each other, the cathode of the organic EL element 50R in the R pixel 51R and the cathode of the organic EL element 50G in the G pixel 51G are physically separated from the cathode of the organic EL element 50B in the B pixel 51B. When the voltages CV-RG and CV-B are the same, on the other hand, the cathodes are not necessarily separated and may be physically unified.

The pixels of the three primary colors R, G and B are described in the first and the second embodiments. However, this display device may have pixels of more than three types corresponding to more than three colors that are emitted from the device. In the first and the second embodiments, the organic EL element corresponding to each of the R, G and B pixels emits light of each of the three primary colors R, G and B, respectively. This invention, however, is applicable to a full color display device using white organic EL elements with color filter layers of the three primary colors R, G and B. Even in the display device using the combination of the white organic EL elements and the color filter layers, the light emission efficiency differs by color. Therefore, independently controlling the power supply voltages to the driver transistors is also effective to improve efficiency of the power supply in such display device, as in the first and the second embodiments. A cross-sectional view of a pixel in such display device is shown in FIG. 15. The pixel includes a glass substrate, a driver transistor TR2 made of a TFT and an insulation film 42 formed on the glass substrate 41, a color filter layer 43 formed in the insulation film 42 and a white organic EL element 44 formed above the color filter layer 43. The color filter layer 43 is a red filter layer in an R pixel, a green filter layer in a G pixel and a blue filter layer in a B pixel. The organic EL element 44 is formed of stacked layers of an anode layer 4a made of ITO (Indium Tin Oxide), a white organic EL layer 4b and a cathode layer 4c. The pixel is bottom emission type. White light generated in the organic EL element 44 goes through the color filter layer 43 to become colored light and is emitted out through the insulation layer 42 and the glass substrate 41.

According to this invention, the power supply voltage for the white balance adjustment is optimized because the power supply voltages supplied to the driver transistors in the pixels having the organic EL elements that emit light of colors different from each other are controlled independently. As a result, power loss in the driver transistors in the pixels is minimized, heating of the display device is suppressed and its power consumption is reduced.

Also, a need for the power supply circuit to provide a high voltage common to all the pixels is eliminated and a load to the power supply circuit is distributed among a plurality of power supply circuits, leading to an improved efficiency in the power supply.

In addition, the power supply voltage for pixels having organic EL elements of high light emission efficiency can be reduced, resulting in reduction in a current to be supplied to the organic EL elements, suppression of a peak current (a current supplied in the maximum brightness) and improvement in reliability.

Furthermore, accuracy in multiple gray level reproduction is improved, since the light emitting periods for the three primary colors can be made equal to each other when white balance is adjusted in the display device using the time division multiplex drive in order to implement the multiple gray level display.

1. A display device comprising:
a plurality of first pixels, each of the first pixels comprising a first light emitting element that emits light of a first color and a first driver transistor that drives the first light emitting element;
a plurality of second pixels, each of the second pixels comprising a second light emitting element that emits light of a second color and a second driver transistor that drives the second light emitting element;
a plurality of third pixels, each of the third pixels comprising a third light emitting element that emits light of a third color and a third driver transistor that drives the third light emitting element;
a data driver providing the first, second and third pixels with signal voltages corresponding to display data;
a first power supply circuit supplying a first potential to the first driver transistors so that currents corresponding to the signal voltages for respective first pixels flow through corresponding first light emitting elements;
a second power supply circuit supplying a second potential to the second driver transistors so that currents corresponding to the signal voltages for respective second pixels flow through corresponding second light emitting elements; and
a third power supply circuit supplying a third potential to the third driver transistors so that currents corresponding to the signal voltages for respective third pixels flow through corresponding third light emitting elements.

2. The display device of claim 1, further comprising a power supply control circuit that controls the first, second and third power supply circuits.

3. The display device of claim 2, wherein the power supply control circuit is configured to perform a white balance adjustment by adjusting the first, second and third potentials.

4. The display device of claim 1, further comprising a switch drive that is disposed in each of the first, second and third pixels and turns on a corresponding driver transistor for a period determined by a corresponding signal voltage applied to the switch device.

5. The display device of claim 4, further comprising a ramp voltage generation circuit that generates a ramp voltage, wherein the switch device comprises a comparator that compares the ramp voltage and the corresponding signal voltage.

6. The display device of claim 1, wherein each of the first, second and third power supply circuits comprises a DC-DC converter.

7. The display device of claim 1, wherein each of the first, second and third driver transistors comprises a thin film transistor.

8. The display device of claim 1, wherein the first, second and third colors correspond to three primary colors.

9. The display device of claim 1, wherein light emission efficiencies of the first, second and third light emitting elements are not equal.

10. The display device of claim 9, wherein a higher potential of the first, second and third potentials is supplied to corresponding driver transistors that drive light emitting elements of a lower efficiency that light emitting elements driven by driver transistors that receives a lower potential of the first, second and third potentials.

11. The display device of claim 1, wherein the first light emitting element comprises a first white light emitting element and a first color filter layer of the first color, the second light emitting element comprises a second white light emitting element and a second color filter layer of the second color, and the third light emitting element comprises a third white light emitting element and a third color filter layer of the third color.

12. A display device comprising:
a first pixel comprising a first light emitting element that emits light of a first color and a first driver transistor that drives the first light emitting element;
a second pixel comprising a second light emitting element that emits light of a second color and a second driver transistor that drives the second light emitting element;
a data driver providing the first and second pixels with signal voltages corresponding to display data;
a first power supply circuit supplying a first potential to the first driver transistor so that a current corresponding to the signal voltage of the first pixel flows through the first light emitting element; and
a second power supply circuit supplying a second potential to the second driver transistor so that a current corresponding to the signal voltage of the second pixel flows through the second light emitting element.

13. The display device of claim 12, further comprising a third pixel comprising a third light emitting element that emits light of a third color and a third driver transistor that drives the third light emitting element, wherein the data driver provides the third pixel with a signal voltage corresponding to the display data and the second power supply circuit supplies the second potential to the third driver transistor so that a current corresponding to the signal voltage of the third pixel flows through the third light emitting element.

14. The display device of claim 13, further comprising a power supply control circuit that controls the first and second power supply circuits.

15. The display device of claim 14, wherein the power supply control circuit is configured to perform a white balance adjustment by adjusting the first and second potentials.

16. The display device of claim 13, further comprising a switch drive that is disposed in each of the first, second and third pixels and turns on a corresponding driver transistor for a period determined by a corresponding signal voltage applied to the switch device.

17. The display device of claim 16, further comprising a ramp voltage generation circuit that generates a ramp voltage, wherein the switch device comprises a comparator that compares the ramp voltage and the corresponding signal voltage.

18. The display device of claim 13, wherein each of the first and second power supply circuits comprises a DC-DC converter.

19. The display device of claim 13, wherein the first, second and third colors correspond to three primary colors.

20. The display device of claim 13, wherein light emission efficiencies of the first, second and third light emitting elements are not equal.

21. The display device of claim 20, wherein a higher potential of the first and second potentials is supplied to a corresponding driver transistor that drives a light emitting element of a lower efficiency that a light emitting element driven by a driver transistor that receives a lower potential of the first and second potentials.

22. The display device of claim 12, wherein the first light emitting element comprises a first white light emitting element and a first color filter layer of the first color, and the second light emitting element comprises a second white light emitting element and a second color filter layer of the second color.
